(19) United States
(12) Patent Application Publication
(10) Pub. No.: US 2026/0336476 A1
(43) Pub. Date: Oct. 29, 2026

(54) SYSTEM AND METHOD FOR CONTROLLING AIR SUPPLY IN FUEL CELL VEHICLE

(71) Applicants: Hyundai Motor Company, Seoul (KR); Kia Corporation, Seoul (KR)

(72) Inventor: Sae Byeok SEUNG, Hwaseong-Si (KR)

(73) Assignees: Hyundai Motor Company, Seoul (KR); Kia Corporation, Seoul (KR)

(21) Appl. No.: 19/343,953

(22) Filed: Sep. 29, 2025

(30) Foreign Application Priority Data
Apr. 28, 2025 (KR) 10-2025-0055053

(51) Int. Cl. B60L 58/31; B60L 15/20; H01M 8/04111; H01M 8/04537; H01M 8/04746

(52) U.S. Cl. CPC B60L 58/31; B60L 15/20; H01M 8/04111; H01M 8/04619; H01M 8/04753; B60L 2240/421; B60L 2240/423; B60L 2250/28; H01M 2250/20

(57) ABSTRACT

In a system and method for controlling air supply in a fuel cell vehicle, the system includes an accelerator pedal controlling an output of a required motor torque amount based on a torque according to revolutions per minute (RPM) of a driving motor according to an input operation amount, and includes a processor determining a required motor output through determining of the required motor torque amount and the RPM of the driving motor, the processor being configured to determine a vehicle starting-up time, and the processor being configured to determine an expected required motor output through determination of the required motor torque amount and a preset minimum motor RPM as the vehicle starting-up time is started in a low speed section having an RPM less than a critical motor RPM.

### CROSS REFERENCE TO RELATED APPLICATION

The present application claims priority to Korean Patent Application No. 10-2025-0055053, filed Apr. 28, 2025, the entire contents of which are incorporated herein for all purposes by this reference.

### BACKGROUND

### Field of the Present Disclosure

The present disclosure relates to a system and method for controlling air supply in a fuel cell vehicle. More particularly, the present disclosure relates to a system and method for controlling air supply in a fuel cell vehicle, the system and method for improving an air supply amount in a low speed driving situation, thereby being capable of resolving a problem of a lack of available output.

### Description of Related Art

Generally, unlike a conventional gasoline engine, a fuel cell electric vehicle is a vehicle that utilizes a fuel cell as a power source, the fuel cell generating electricity by combining hydrogen and oxygen in air.

Since such a fuel cell electric vehicle does not have an engine, the fuel cell electric vehicle does not emit exhaust gas or contaminants. Furthermore, since hydrogen, which is capable of being obtained continuously from natural sources, is used as a fuel of the fuel cell electric vehicle, the application of the fuel cell electric vehicle is gaining attention as interest in the environment grows recently.

Here, a hydrogen fuel cell system includes a hydrogen supplying apparatus and an air supplying apparatus that are respectively configured to supply hydrogen and air, and includes a fuel cell stack configured to receive hydrogen and air by the hydrogen supplying apparatus and the air supplying apparatus and to generate electrical energy from an electrochemical reaction of hydrogen and air.

Accordingly, the electrical energy generated from the fuel cell stack may be supplied to a driving motor of a vehicle or may be stored in a high voltage battery capable of being charged and discharged.

At the present time, it is very important to control an air flow rate supplied to the fuel cell stack for generating the electrical energy, and the air flow rate may be determined by a required output used in a general driving situation.

However, in a situation in which the speed of the vehicle is low, the required output used to determine the air flow rate is reduced because the motor Revolutions Per Minute (RPM) is low under low accelerator pedal input conditions, and the required output becomes the same as an output actually used, so that the required output does not anticipate the actual output.

Accordingly, in a situation in which the motor revolutions per minute (RPM) increases due to increased accelerator pedal input and in a situation in which a large output is required reaches, the air supply is delayed due to the non-predictive required output, so that a situation in which the available output is insufficient due to the delay of the air supply speed caused by the belated air supply command occurs.

### BRIEF SUMMARY

Accordingly, the present disclosure has been made keeping in mind the above problems occurring in the related art, and an objective of the present disclosure is to provide a system and method for controlling air supply in a fuel cell vehicle, the system and method being configured so that a required output that is required at a future time in which a motor RPM is increased is reflected in advance so that the air supply is provided in advance in a low speed driving situation in which a required output is reflected small due to a relatively low motor RPM, the system and method being configured for solving a problem that an air supply command is delayed due to the required output which is dependent on the motor RPM and which is slowly increased is configured for being solved, being configured for solving a problem in which an available output is insufficient.

According to various aspects of the present disclosure, there is disposed a system for controlling air supply in a fuel cell vehicle, the system including: an accelerator pedal controlling an output of a required motor torque amount based on a torque according to revolutions per minute (RPM) of a driving motor according to an input operation amount; and a processor determining a required motor output through determining of the required motor torque amount and the RPM of the driving motor, the processor being configured to determine a vehicle starting-up time, and the processor being configured to determine an expected required motor output through determination of the required motor torque amount and a preset minimum motor RPM as the vehicle starting-up time is started in a low speed section having an RPM less than a predetermined motor RPM, wherein the processor generates a weighting value by comparing the expected required motor output with the required motor output, determines an adjusted required fuel cell output by reflecting the weighting value on a required fuel cell output distributed from the required motor output, determines an available output based on the adjusted required fuel cell output when the vehicle starting-up time is started in the low speed section, and transmits the available output to an air compressor.

Here, the predetermined motor RPM may be set as the RPM of the driving motor at a time when the required motor torque amount is started to be decreased.

Furthermore, the processor is configured to determine the required motor output through determining of the required motor torque amount and a current RPM of the driving motor as the vehicle starts up in medium and high speed sections having an RPM equal to or greater than the predetermined motor RPM.

Furthermore, the minimum motor RPM may be set as the RPM of the driving motor at a time when medium and high speed sections having an RPM equal to or greater than the predetermined motor RPM are started.

Furthermore, the processor may be configured to determine a deviation through a difference between the expected required motor output and the required motor output in the low speed section, and may be configured to generate the weighting value by use of a predetermined setting map.

Such a setting map may be determined based on the expected required motor output and the deviation.

Furthermore, in the setting map, a relatively large weighting value may be determined as the deviation is large and the expected required motor output is high, and a relatively small weighting value may be determined as the deviation is small and the expected required motor output is low.

Furthermore, the processor may be configured to determine the required motor output through determining of the required motor torque amount and a current RPM of the driving motor, and may be configured to determine the required fuel cell output for reflecting the weighting value by distributing the required motor output to a fuel cell and a battery.

Furthermore, the processor may be configured to determine the required fuel cell output, and may be configured to divide the required fuel cell output so that a required fuel cell output for determining an air supply amount and a required fuel cell output for determining a voltage command are determined.

Furthermore, the processor may be configured to determine the available output with an air flow rate supplied through an air supply command by the adjusted required fuel cell output, and may be configured to transmit the available output to the air compressor.

Meanwhile, according to various aspects of the present disclosure, there is provided a method for controlling air supply in a fuel cell vehicle, the method including: a required output generation process which is performed by a processor and in which a required motor torque amount is output based on a torque according to revolutions per minute (RPM) of a driving motor according to an operation amount input from an accelerator pedal and then a required motor output is determined through determining of the required motor torque amount and the RPM of the driving motor; a weighting value generation process which is performed by the processor and in which a vehicle starting-up time is determined, an expected required motor output is selectively determined through determining of the required motor torque amount and a preset minimum motor RPM, and a weighting value is generated by comparing the expected required motor output with the required motor output; and an required air supply amount generation process which is performed by the processor and in which an adjusted required fuel cell output is determined by reflecting the weighting value on a required fuel cell output distributed from the required motor output, an available output based on the adjusted required fuel cell output is determined when the vehicle starting-up time is started in a low speed section, and the available output is transmitted to an air compressor.

Here, in the weighting value generation process, by use of the processor, the vehicle starting-up time may be determined, and the expected required motor output may be selectively determined as the vehicle starting-up time is started in the low speed section having an RPM less than a predetermined motor RPM.

Furthermore, the predetermined motor RPM may be set as the RPM of the driving motor at a time when the required motor torque amount is started to be decreased.

Furthermore, in the weighting value generation process, by use of the processor, the required motor output is determined through determining of the required motor torque amount and a current RPM of the driving motor as the vehicle starts up in medium and high speed sections having an RPM equal to or greater than the predetermined motor RPM.

Furthermore, the minimum motor RPM may be set as the RPM of the driving motor at a time when medium and high speed sections having an RPM equal to or greater than the predetermined motor RPM are started.

Furthermore, in the weighting value generation process, by use of the processor, a deviation may be determined through a difference between the expected required motor output and the required motor output in the low speed section, and the weighting value may be generated by use of a setting map that is predetermined based on the expected required motor output and the deviation.

Furthermore, in the setting map, a relatively large weighting value may be determined as the deviation is large and the expected required motor output is high, and a relatively small weighting value may be determined as the deviation is small and the expected required motor output is low.

Furthermore, in the required output generation process, by use of the processor, the required motor output may be determined through determining of the required motor torque amount and a current RPM of the driving motor, and the required fuel cell output for reflecting the weighting value may be determined by distributing the required motor output to a fuel cell and a battery.

Furthermore, in the required output generation process, by use of the processor, the required fuel cell output may be determined, and the required fuel cell output may be divided so that a required fuel cell output for determining an air supply amount and a required fuel cell output for determining a voltage command are determined.

Furthermore, in the required air supply amount generation process, by use of the processor, the available output may be determined with an air flow rate supplied through an air supply command by the adjusted required fuel cell output, and the available output may be transmitted to the air compressor.

According to various aspects of the present disclosure, in the low speed driving situation in which the required output is reflected small due to the relatively low motor RPM, the output that is required at a future time in which the motor RPM is increased is reflected in advance, so that the air supply is provided in advance. Through this, a problem that the air supply command is delayed due to the required output which is dependent on the motor RPM and which is slowly increased is configured for being solved, so that there is an effect that a problem in which the available output is insufficient is configured for being solved.

Furthermore, according to various aspects of the present disclosure, the deviation is determined by use of the difference between the current required output and the output that is required at a future time, the required air supply amount is determined based on the required output adjusted according to the weighting value generated by reflecting such a deviation, and the required air supply amount becomes identical to the required output of the fuel cell, so that air oversupplying is configured for being prevented, including an effect that a stabilization of air supply is configured for being realized.

### BRIEF DESCRIPTION OF THE DRAWINGS

The above and other objectives, features, and other advantages of the present disclosure will be more clearly understood from the following detailed description when taken in conjunction with the accompanying drawings, in which:

FIG. 1 is a view exemplarily illustrating a system for controlling air supply in a fuel cell vehicle according to an exemplary embodiment of the present disclosure;

FIG. 2 is a view exemplarily illustrating various exemplary embodiments illustrating a required motor torque amount for the system for controlling air supply in the fuel cell vehicle according to an exemplary embodiment of the present disclosure;

FIG. 3 is a view exemplarily illustrating the various exemplary embodiments illustrating an expected required output for the system for controlling air supply in the fuel cell vehicle according to an exemplary embodiment of the present disclosure;

FIG. 4 is a view exemplarily illustrating various exemplary embodiments illustrating a required motor torque amount for the system for controlling air supply in the fuel cell vehicle according to an exemplary embodiment of the present disclosure;

FIG. 5 is a view exemplarily illustrating the various exemplary embodiments illustrating an expected required output for the system for controlling air supply in the fuel cell vehicle according to an exemplary embodiment of the present disclosure;

FIG. 6 is a view exemplarily illustrating an available output for the system for controlling air supply in the fuel cell vehicle according to an exemplary embodiment of the present disclosure;

FIG. 7 is a view sequentially illustrating a required output generation process for a method for controlling air supply in a fuel cell vehicle according to another exemplary embodiment of the present disclosure;

FIG. 8 is a view sequentially illustrating a weighting value generation for the method for controlling air supply in the fuel cell vehicle according to another exemplary embodiment of the present disclosure;

FIG. 9 is a view sequentially illustrating a required air supply amount generation process for the method for controlling air supply in the fuel cell vehicle according to another exemplary embodiment of the present disclosure;

FIG. 10 is a view exemplarily illustrating an available output in conventional medium and high speed sections; and

FIG. 11 is a view exemplarily illustrating an available output in a conventional low speed section.

### DETAILED DESCRIPTION

Hereinafter, an exemplary embodiment of the present disclosure will be described in detail with reference to the accompanying drawings.

Advantages and features of the present disclosure, and methods of achieving the advantages and the features, will be apparent from the accompanying drawings and from embodiments that are described in detail below.

However, the present disclosure is not limited to the exemplary embodiments included below, but may be implemented in various different forms. The exemplary embodiments are intended to complete the present disclosure of the present disclosure and disposed to fully inform the skilled in the art to which the present disclosure pertains of the scope of the present disclosure. The present disclosure is defined only by the scope of the claims.

Furthermore, detailed descriptions related to well-known functions or configurations may be omitted in order not to unnecessarily obscure subject matter of the present disclosure.

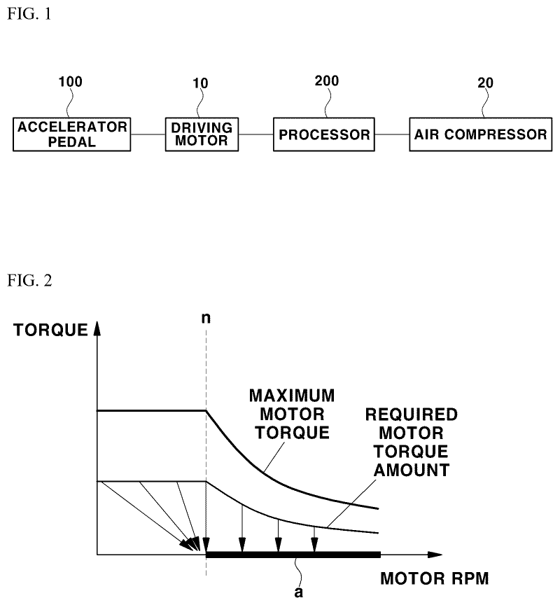

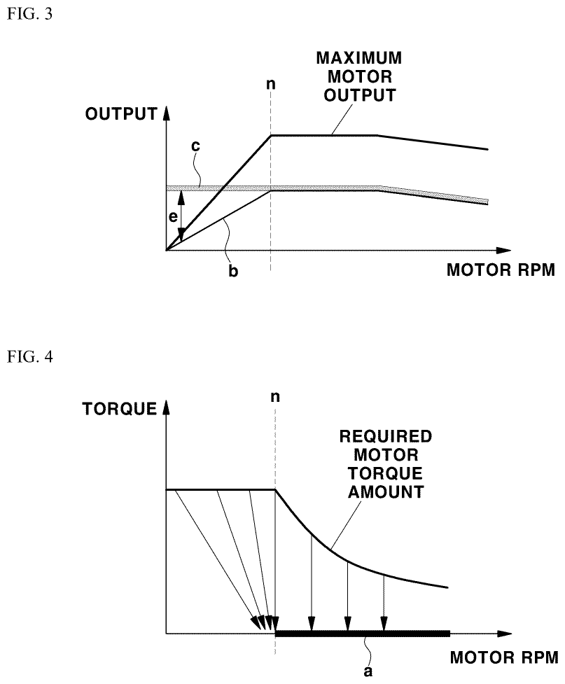

FIG. 1 is a view exemplarily illustrating a system for controlling air supply in a fuel cell vehicle according to an exemplary embodiment of the present disclosure, FIG. 2 is a view exemplarily illustrating various exemplary embodiments illustrating a required motor torque amount for the system for controlling air supply in the fuel cell vehicle according to an exemplary embodiment of the present disclosure, and FIG. 3 is a view exemplarily illustrating the various exemplary embodiments illustrating an expected required output for the system for controlling air supply in the fuel cell vehicle according to an exemplary embodiment of the present disclosure.

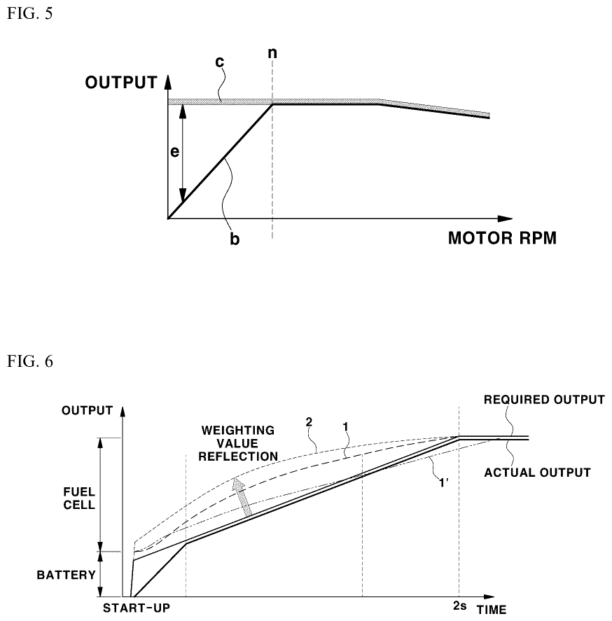

Furthermore, FIG. 4 is a view exemplarily illustrating various exemplary embodiments illustrating a required motor torque amount for the system for controlling air supply in the fuel cell vehicle according to an exemplary embodiment of the present disclosure, FIG. 5 is a view exemplarily illustrating the various exemplary embodiments illustrating an expected required output for the system for controlling air supply in the fuel cell vehicle according to an exemplary embodiment of the present disclosure, and FIG. 6 is a view exemplarily illustrating an available output for the system for controlling air supply in the fuel cell vehicle according to an exemplary embodiment of the present disclosure.

As illustrated in FIG. 1, the system for controlling air supply in the fuel cell vehicle according to an exemplary embodiment of the present disclosure includes an accelerator pedal 100 and a processor 200.

According to an input operation amount, the accelerator pedal 100 outputs a required motor torque amount based on a torque according to a rotation speed (RPM) of a driving motor 10.

Generally, a vehicle is operated based on an operation amount of the accelerator pedal 100, such as 25%, 50%, 100% and the like, which represents a driver's demand. As illustrated in FIG. 2, in a situation in which the operation amount is input from the accelerator pedal 100, the required motor torque amount according to the RPM of the driving motor 10 is output. Therefore, based on such a required motor torque amount, the RPM of the driving motor 10 is determined and a required motor output b is generated as illustrated in FIG. 3.

Here, in a hydrogen fuel cell vehicle, an output of a fuel cell and an output of a battery are used to satisfy the generated required motor output b. However, the battery is configured for immediately generating the required output when a charged amount of the battery is sufficient, but the fuel cell requires a predetermined amount of time until sufficient air for generating the required output is supplied. Therefore, rapid air supply for satisfying the required motor output b demanded by the driver, which is an available output 1, is required to be prepared.

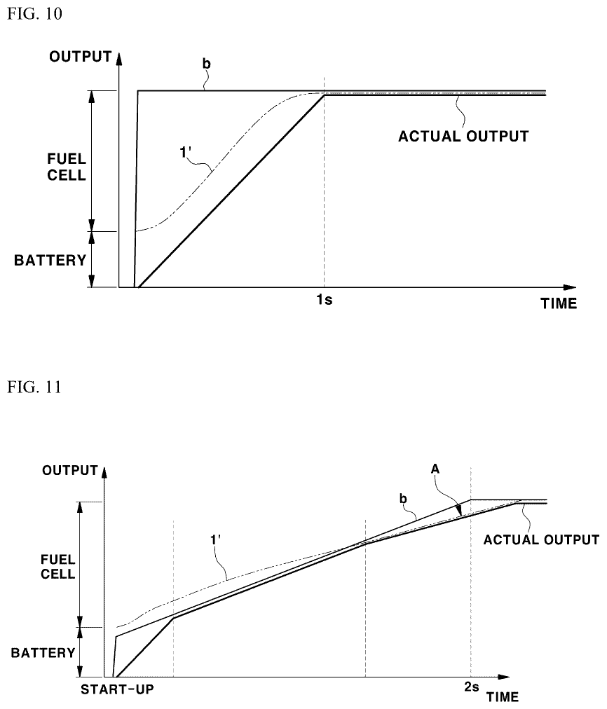

In conventional medium and high speed driving situations, the required motor output b used to determine an air supply amount of a fuel cell system is determined by multiplying a required motor torque amount transmitted from the accelerator pedal 100 by a current RPM of the driving motor 10. Therefore, as illustrated in FIG. 10, the required motor output b precedes the actual torque generated at the actual output (the torque that gradually increases due to a torque increase inclination), so that sufficient air configured for satisfying the available output 1 of the fuel cell is supplied at the time when the actual output is generated.

However, in a low speed driving situation, the required motor output b used to determine the air supply amount of the fuel cell system is determined by multiplying the required motor torque amount transmitted from the accelerator pedal 100 by the current RPM of the driving motor 10 as same as in the medium and high speed driving situations. However, as illustrated in FIG. 11, the RPM of the driving motor 10 is relatively low, the required motor output b is also output as a small value, and the actual output and the required motor output b become identical. That is, the required motor output b becomes dependent on a speed at which the RPM of the driving motor 10 increases. For example, in an area A at the time in which two seconds are elapsed, the available output 1 is not prepared.

Consequently, when the vehicle reaches a driving situation at which the RPM of the driving motor 10 is required to be increased to achieve a high output, the air supply requirement is delayed. As a result, the air supply is slowed down due to the belated air supply command, so that a situation in which the available output 1 is insufficient occurs.

To the present end, the processor 200 is configured to determine the required motor output b through determining of the required motor torque amount and the RPM of the driving motor 10, but is configured to determine the vehicle start-up timing, and as the start-up of the vehicle is performed in a low speed section below a critical motor RPM, is configured to determine an expected required motor output c through determining of the required motor torque amount and a preset minimum motor RPM as illustrated in FIG. 3 and FIG. 5.

Furthermore, the processor 200 generates a weighting value through a difference between the determined expected required motor output c and the required motor output, reflects the weighting factor in a required fuel cell output distributed from the required motor output b, and is configured to determine an adjusted required fuel cell output 2 as illustrated in FIG. 6. Accordingly, in a situation in which the vehicle is started-up at the low speed section, the available output 1 is determined based on the adjusted required fuel cell output 2 that is determined, the available output 1 precedes the actual output 1 (deleting the area A in FIG. 11), so that an adjusted air flow rate is generated through an air compressor 20.

Various embodiments described in the present specification may be implemented as software including one or more instructions that are stored in a storage medium (e.g., an internal memory or an external memory) that is readable by a machine (e.g., a computing apparatus or the processor 200). For example, the machine or the processor 200 may invoke at least one of the one or more instructions stored in the storage medium, and may execute the invoked instruction. The one or more instructions may include a code generated by a complier or a code executable by an interpreter. The storage medium readable by the machine or the processor 200 may be provided in a form of a non-transitory storage medium. Here, the term “non-transitory” simply means that the storage medium is a tangible device, and does not include a signal (e.g., an electromagnetic wave), but this term does not differentiate between cases where data is semi-permanently stored in the storage medium and where the data is temporarily stored in the storage medium.

The processor 200 may include hardware (e.g., a controller and the like) for implementing various embodiments described in the present specification. The processor 200 may be formed of at least one core, and may include a processor for data analysis and deep learning such as a Central Processing Unit (CPU) of a computing machine, a General Purpose Graphics Processing Unit (GPGPU), a Tensor Processing Unit (TPU), an Application Processor (AP), an Application Specific Integrated Circuit (ASIC), a Field Programmable Gate Array (FPGA), and so on. The processor for deep learning may be controlled to process input data according to a predefined operation rule or an artificial intelligence model stored in a memory. In a situation in which one or more processors are dedicated to artificial intelligence, the processor dedicated to artificial intelligence may be designed with a hardware structure specialized for processing a specific artificial intelligence model.

Meanwhile, to determine the starting-up time of the vehicle, the processor 200 compares the current RPM of the driving motor 10 with a critical motor RPM n. Furthermore, as the starting-up of the vehicle at the low speed section below the critical motor RPM n is performed, the processor 200 is configured to determine the determined expected required motor output c through determining of the required motor torque amount and the preset minimum motor RPM (see FIG. 3 and FIG. 5). The critical motor RPM n may be set as the RPM of the driving motor 10 at the time when the required motor torque amount is started to be decreased.

As illustrated in FIG. 2 and FIG. 4, the required motor torque amount is output differently according to the 50% and 100% operation amounts of the accelerator pedal 100. Here, in a situation in which the RPM of the driving motor 10 reaches the critical motor RPM equal to or greater than a predetermined RPM, the required motor torque amount is decreased.

As a result, before the required motor torque amount is decreased, it may be determined that the vehicle is driven in the low speed section in which the set operation amount of the accelerator pedal 100 is not achieved. Therefore, the corresponding motor RPM is set as the critical motor RPM n, so that whether the vehicle is driven at the low speed or is driven at the medium and high speeds is configured for being determined based on the critical motor RPM n.

When it is determined that the vehicle is driven at the low speed based on the determination standard described above, the processor 200 is configured to determine the expected required motor output c by multiplying the required motor torque amount by a preset minimum motor RPM a not by multiplying the required motor torque amount by the current RPM of the driving motor 10.

The minimum motor RPM a is set as the RPM of the driving motor 10 at the time when the medium and high speed sections having the RPM equal to or greater than critical motor RPM n are started. Through this, by multiplying the required motor torque amount by the preset minimum motor RPM a, the required motor output at the medium and high speed sections after the low speed section are expected, so that the expected required motor output c is determined as illustrated in FIG. 3 and FIG. 5.

Here, in a situation in which the vehicle is driven at the medium and high speed sections having the RPM equal to or greater than the critical motor RPM n, the processor 200 is configured to determine the required motor output b through determining of the required motor torque amount and the current RPM of the driving motor 10.

Meanwhile, the processor 200 is configured to determine a deviation e by use of a difference between the expected required motor output c and the required motor output in the low speed section, and generates a weighting value by use of a predetermined setting map as shown in [Table 1] below.

TABLE 1

| | 0(e) | 25(e) | 50(e) | 75(e) | 100(e) |
|---|---|---|---|---|---|
| 0(c) | 1 | | | | |
| 25(c) | 1 | 2 | | | |
| 50(c) | 1 | 2 | 3 | | |
| 75(c) | 1 | 2 | 3 | 4 | |
| 100(c) | 1 | 2 | 3 | 4 | 5 |

The setting map is determined based on the expected required motor output c and the deviation e. More preferably, in the setting map, a relatively large weighting value is determined when the deviation e is higher and the expected required motor output c is higher, and a relatively small weighting value is determined when the deviation e is smaller and the expected required motor output c is smaller.

Here, a reason that the setting map is determined based on not only the deviation e at an x-axis but also the expected required motor output c at a y-axis is to prevent air oversupplying. In a state in which the 50% operation amount of the accelerator pedal 100 referring to FIG. 3 is input, if the weighting value of five is reflected in the required motor output b in the same manner as in a state in which the 100% operation amount of the accelerator pedal 100 referring to FIG. 5 is input, the required motor output b is determined to a level exceeding the expected required motor output c. Therefore, in a situation in which not only the deviation e at the x-axis but also the expected required motor output c at the y-axis are applied as variables for determining the weighting value, the air oversupplying that exceeds the operation amount of the accelerator pedal 100 may be prevented.

Meanwhile, the processor 200 is configured to determine the required motor output through determining of the required motor torque amount and the current RPM of the driving motor 10, and distributes the required motor output to the fuel cell and the battery according to a predetermined setting ratio, determining the required fuel cell output for reflecting the weighting value.

Here, the processor 200 is configured to determine the required fuel cell output by dividing and determining the required fuel cell output for determining the air supply amount and the required fuel cell output for determining a voltage command. Among these two required fuel cell outputs, the required fuel cell output for determining the air supply amount is applied for determining the available output, and then the adjusted required fuel cell output 2 is determined.

That is, the processor 200 is configured to determine the adjusted required fuel cell output 2 by multiplying the required fuel cell output for determining the air supply amount by the weighting value. Furthermore, as illustrated in FIG. 6, the available output 1 is determined by the air flow rate supplied through an air supply command by such an adjusted required fuel cell output 2, and is transmitted to the air compressor 20, so that an adjusted air flow rate may be generated.

Accordingly, by the adjusted required fuel cell output 2 in which the weighting value is reflected in the low speed section of the vehicle, the processor 200 is configured so that the available output 1 is determined to precede the actual output compared to an existing available output 1′ (see FIG. 11). Accordingly, in the low speed situation in which the required motor output is reflected small due to the low RPM of the driving motor 10, the output required at a future time in which the RPM of the driving motor 10 is increased is reflected in advance, so that the air supply through the air compressor 20 is disposed in advance, being configured for preventing the situation in which the available output 1 is insufficient.

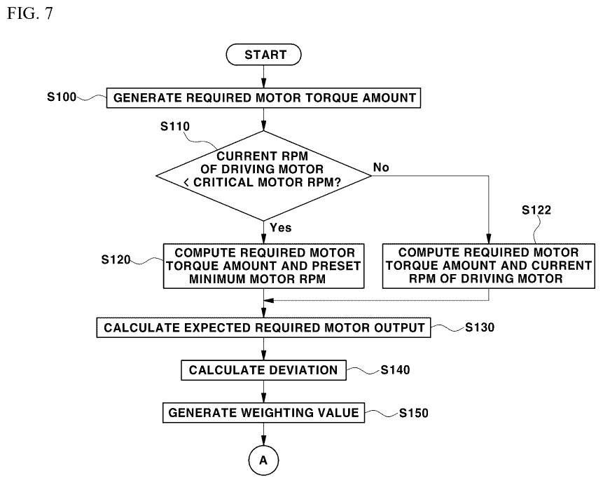

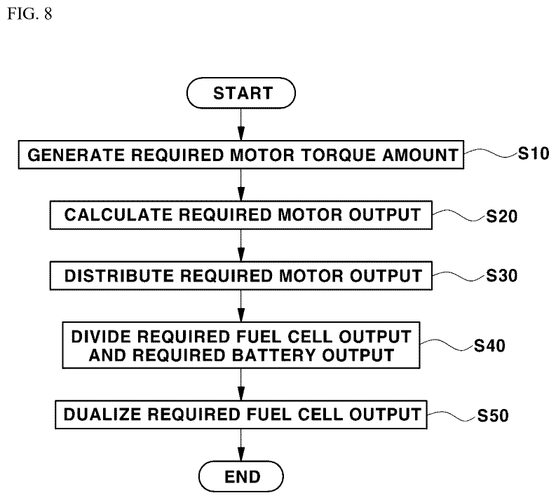

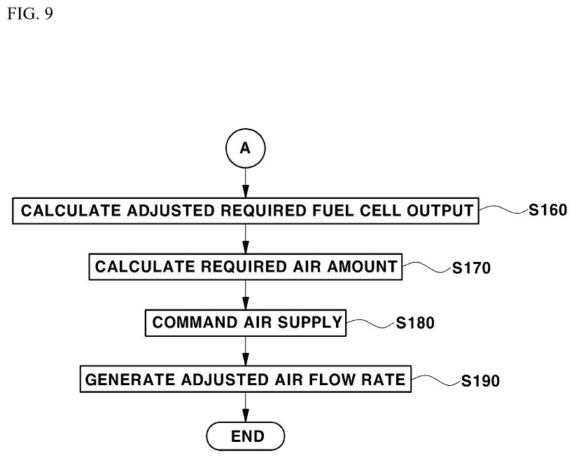

FIG. 7 is a view sequentially illustrating a required output generation process for a method for controlling air supply in a fuel cell vehicle according to another exemplary embodiment of the present disclosure, FIG. 8 is a view sequentially illustrating a weighting value generation process for the method for controlling air supply in the fuel cell vehicle according to another exemplary embodiment of the present disclosure, and FIG. 9 is a view sequentially illustrating an required air supply amount generation process for the method for controlling air supply in the fuel cell vehicle according to another exemplary embodiment of the present disclosure.

As shown in FIG. 7, in a required output generation, according to the operation amount input from the accelerator pedal 100, a required motor torque amount is output through the processor 200 based on a torque according to the RPM of the driving motor 20 in S100.

At the present time, to determine the starting-up time of the vehicle, the processor 200 compares the current RPM of the driving motor 10 with the critical motor RPM n in S110. Furthermore, as the starting-up of the vehicle at the low speed section below the critical motor RPM n is performed, the processor 200 determines the required motor torque amount and the preset minimum motor RPM in S120, and is configured to determine the expected required motor output c in $130 (see FIG. 3 and FIG. 5). The critical motor RPM n may be set as the RPM of the driving motor 10 at the time when the required motor torque amount is started to be decreased.

As illustrated in FIG. 2 and FIG. 4, the required motor torque amount is output differently according to the 50% and 100% operation amounts of the accelerator pedal 100. Here, in a situation in which the RPM of the driving motor 10 reaches the critical motor RPM equal to or greater than a predetermined RPM, the required motor torque amount is decreased.

As a result, before the required motor torque amount is decreased, it may be determined that the vehicle is driven in the low speed section in which the set operation amount of the accelerator pedal 100 is not achieved. Therefore, the corresponding motor RPM is set as the critical motor RPM n, so that whether the vehicle is driven at a low speed or is driven at a medium or high speed is configured for being determined based on the critical motor RPM n.

When it is determined that the vehicle is driven at the low speed based on the determination standard described above, the processor 200 is configured to determine the expected required motor output c by multiplying the required motor torque amount by the preset minimum motor RPM a in S130.

Here, in a situation in which the vehicle is driven at the medium and high speed sections having the RPM equal to or greater than the critical motor RPM n, the processor 200 is configured to determine the required motor output b through determining of the required motor torque amount and the current RPM of the driving motor 10 in S122.

Meanwhile, the processor 200 is configured to determine the deviation e by use of the difference between the expected required motor output c and the required motor output in the low speed section in S140, and generates the weighting value by use of the predetermined setting map as shown in the exemplary embodiment described above.

Meanwhile, the processor 200 distributes the required motor output to the fuel cell and the battery according to the predetermined setting ratio, and is configured to determine the adjusted required fuel cell output 2 by multiplying the determined required fuel cell output by the weighting value.

Here, the required fuel cell output is described with reference to FIG. 8, and is as follows.

First, through the processor 200, the required motor torque amount is output based on the torque according to the RPM of the driving motor 10 according to the operation amount input from the accelerator pedal 100 in S10, and the required motor output b is determined through determining of the output required motor torque amount and the current RPM of the driving motor 10 in S20.

The processor 200 distributes the required motor output b determined as described above to the fuel cell and the battery in S30, and respectively is configured to determine the required fuel cell output and the battery required output in S40.

At the present time, the processor 200 is configured to determine the required fuel cell output distributed from the required motor output b in S40, but the processor 200 divides and is configured to determine the required fuel cell output for determining the air supply amount and the required fuel cell output for determining the voltage command in S50. Among these two required fuel cell outputs, the required fuel cell output for determining the air supply amount is selectively applied for determining the adjusted required fuel cell output 2 (see FIG. 9) in S160, and then the adjusted required fuel cell output 2 is determined.

Furthermore, as illustrated in FIG. 9, in a situation in which the adjusted required fuel cell output 2 is determined by multiplying the required fuel cell output by the weighting value generated through the predetermined setting map (see FIG. 7) in S160, the processor 200 generates the air supply amount for supplying air to the fuel cell.

In other words, the processor 200 is configured to determine the air required amount based on the determined adjusted required fuel cell output 2 in S170, and is configured to determine the available output 1 by use of the air flow rate supplied through the air supply command by the adjusted required fuel cell output 2 and transmits the available output 1 to the air compressor 20 in S180, so that the adjusted air flow rate is generated in S190.

Accordingly, by the adjusted required fuel cell output 2 in which the weighting value is reflected in the low speed section of the vehicle, the processor 200 is configured so that the available output 1 precedes the actual output compared to the existing available output 1′ (see FIG. 11). Accordingly, in the low speed situation in which the required motor output is reflected small due to the predetermined RPM of the driving motor 10, the output required at a future time in which the RPM of the driving motor 10 is increased is reflected in advance, so that the air supply is provided in advance, being configured for preventing the situation in which the available output 1 is insufficient.

In an exemplary embodiment of the present disclosure, in the low speed driving situation in which the required output is reflected small due to the relatively low motor RPM, the output that is required at a future time in which the motor RPM is increased is reflected in advance, so that the air supply is provided in advance. Through this, a problem of a situation in which the air supply command is delayed due to the required output which is dependent on the motor RPM and which is slowly increased is configured for being solved, so that there is an effect that a problem in which the available output is insufficient is configured for being solved.

Furthermore, in an exemplary embodiment of the present disclosure, the deviation is determined by use of the difference between the current required output and the output that is required at a future time, the required air supply amount is determined based on the required output adjusted according to the weighting value generated by reflecting such a deviation, and the required air supply amount becomes identical to the required output of the fuel cell, so that air oversupplying is capable of being prevented, thereby having an effect that a stabilization of air supply is capable of being realized.

While the present disclosure has been and described with reference to embodiment(s) illustrated in the drawings, the embodiment(s) are only illustrative, and it will be understood that various modifications may include those skilled in the art, and all or some of the described embodiment(s) may be selectively configured in combination. Accordingly, the true technical scope of the present disclosure should be defined by the technical spirit of the appended claims.

What is claimed is:

1. A system for controlling air supply in a fuel cell vehicle, the system comprising:
an accelerator pedal controlling an output of a required motor torque amount based on a torque according to revolutions per minute (RPM) of a driving motor according to an input operation amount; and
a processor determining a required motor output through determining of the required motor torque amount and the RPM of the driving motor, wherein the processor determines a vehicle starting-up time, and determines an expected required motor output through determination of the required motor torque amount and a preset minimum motor RPM as the vehicle starting-up time is started in a low speed section including an RPM less than a predetermined motor RPM,
wherein the processor generates a weighting value by comparing the expected required motor output with the required motor output, determines an adjusted required fuel cell output by reflecting the weighting value on a required fuel cell output distributed from the required motor output, determines an available output based on the adjusted required fuel cell output based on that the vehicle starting-up time is started in the low speed section, and transmits the available output to an air compressor.

2. The system of claim 1, wherein the predetermined motor RPM is set as the RPM of the driving motor at a time based on that the required motor torque amount is started to be decreased.

3. The system of claim 1, wherein the processor determines the required motor output through determining of the required motor torque amount and a current RPM of the driving motor based on that the vehicle starts up in medium and high speed sections including an RPM equal to or greater than the predetermined motor RPM.

4. The system of claim 1, wherein the minimum motor RPM is set as the RPM of the driving motor at a time based on that medium and high speed sections including an RPM equal to or greater than the predetermined motor RPM are started.

5. The system of claim 1, wherein the processor determines a deviation through a difference between the expected required motor output and the required motor output in the low speed section, and generates the weighting value by use of a predetermined setting map.

6. The system of claim 5, wherein the setting map is determined based on the expected required motor output and the deviation.

7. The system of claim 5, wherein, in the setting map, a relatively large weighting value is determined as the deviation is larger and the expected required motor output is higher, and a relatively small weighting value is determined as the deviation is smaller and the expected required motor output is lower.

8. The system of claim 1, wherein the processor determines the required motor output through determining of the required motor torque amount and a current RPM of the driving motor, and determines the required fuel cell output for reflecting the weighting value by distributing the required motor output to a fuel cell and a battery.

9. The system of claim 8, wherein the processor determines the required fuel cell output, and divides the required fuel cell output so that a required fuel cell output for determining an air supply amount and a required fuel cell output for determining a voltage command are determined.

10. The system of claim 1, wherein the processor determines the available output with an air flow rate supplied through an air supply command by the adjusted required fuel cell output, and transmits the available output to the air compressor.

11. A method for controlling air supply in a fuel cell vehicle, the method comprising:
a required output generation process which is performed by a processor and in which a required motor torque amount is output based on a torque according to revolutions per minute (RPM) of a driving motor according to an operation amount input from an accelerator pedal and then a required motor output is determined through determining of the required motor torque amount and the RPM of the driving motor;
a weighting value generation process which is performed by the processor and in which a vehicle starting-up time is determined, an expected required motor output is selectively determined through determining of the required motor torque amount and a preset minimum motor RPM, and a weighting value is generated by comparing the expected required motor output with the required motor output; and
a required air supply amount generation process which is performed by the processor and in which an adjusted required fuel cell output is determined by reflecting the weighting value on a required fuel cell output distributed from the required motor output, an available output based on the adjusted required fuel cell output is determined based on that the vehicle starting-up time is started in a low speed section including an RPM less than a predetermined motor RPM, and the available output is transmitted to an air compressor.

12. The method of claim 11, wherein, in the weighting value generation process, by use of the processor, the vehicle starting-up time is determined, and the expected required motor output is selectively determined as the vehicle starting-up time is started in the low speed section.

13. The method of claim 12, wherein the predetermined motor RPM is set as the RPM of the driving motor at a time based on that the required motor torque amount is started to be decreased.

14. The method of claim 12, wherein, in the weighting value generation process, by use of the processor, the required motor output is determined through determining of the required motor torque amount and a current RPM of the driving motor as the vehicle starts up in medium and high speed sections having an RPM equal to or greater than the predetermined motor RPM.

15. The method of claim 11, wherein the minimum motor RPM is set as the RPM of the driving motor at a time based on that medium and high speed sections having an RPM equal to or greater than the predetermined motor RPM are started.

16. The method of claim 11, wherein, in the weighting value generation process, by use of the processor, a deviation is determined through a difference between the expected required motor output and the required motor output in the low speed section, and the weighting value is generated by use of a setting map that is predetermined based on the expected required motor output and the deviation.

17. The method of claim 16, wherein, in the setting map, a relatively large weighting value is determined as the deviation is larger and the expected required motor output is higher, and a relatively small weighting value is determined as the deviation is smaller and the expected required motor output is lower.

18. The method of claim 11, wherein, in the required output generation process, by use of the processor, the required motor output is determined through determining of the required motor torque amount and a current RPM of the driving motor, and the required fuel cell output for reflecting the weighting value is determined by distributing the required motor output to a fuel cell and a battery.

19. The method of claim 18, wherein, in the required output generation process, by use of the processor, the required fuel cell output is determined, and the required fuel cell output is divided so that a required fuel cell output for determining an air supply amount and a required fuel cell output for determining a voltage command are determined.

20. The method of claim 11, wherein, in the required air supply amount generation process, by use of the processor, the available output is determined with an air flow rate supplied through an air supply command by the adjusted required fuel cell output, and the available output is transmitted to the air compressor.
